(19) United States
(12) Patent Application Publication
(10) Pub. No.: US 2013/0169061 A1
(43) Pub. Date: Jul. 4, 2013

(54) APPLIANCE WITH A WIRELESS ELECTRICAL ENERGY TRANSMISSION DEVICE

(71) Applicants: Vladimir Vitalievich Miroshnichenko, Ljubertsi (RU); Vitaly Evgenievich Pilkin, Moscow (RU)

(72) Inventors: Vladimir Vitalievich Miroshnichenko, Ljubertsi (RU); Vitaly Evgenievich Pilkin, Moscow (RU)

(21) Appl. No.: 13/814,551

(22) PCT Filed: Aug. 3, 2011
(86) PCT No.: PCT/RU11/00581

§ 371 Date: Feb. 6, 2013

(30) Foreign Application Priority Data
Sep. 2, 2010 (RU) 2010136667

(51) Int. Cl. H04B 5/00

(52) U.S. Cl. CPC H04B 5/0037
USPC 307/104

(57) ABSTRACT

The invention relates to electrical engineering. The technical result is to increase the operating efficiency of the wireless electrical energy transmission device and to reduce the potential hazard of the wireless electrical energy transmission device to humans. The essence of the invention is that in an appliance, which requires electrical power supply to operate, comprising at least one wireless electrical energy transmission device (WEETD), at least one specified WEETD is accommodated fully or partially inside specified appliance housing, herewith a wireless transmission of electrical energy to at least one technical mean, which is an integral part of the appliance, is carried out through at least one WEETD.

### CROSS-REFERENCE TO RELATED APPLICATIONS

This application is a U.S. national stage application of the PCT application PCT/RU2011/000581 filed on 3 Aug. 2011, published as WO 2012/030253, whose disclosure is incorporated herein in its entirety by reference, which PCT application claims priority of a Russian Federation application RU2010136667 filed on 2 Sep. 2010.

### FIELD OF THE INVENTION

The invention relates to electrical engineering and can be used to increase the operating efficiency of devices for the wireless transmission of electrical energy and to reduce the potential hazard of devices for the wireless transmission of electrical energy to humans.

### BACKGROUND OF THE INVENTION

There are a number of different electronic, automatic and other appliances (hereinafter referred to as “appliances”), which require electrical power (electricity). These appliances consist of technical means, requiring electrical energy for their functioning. Specified technical means receive electricity by wire i.e. electricity is transmitted using conductive elements in electrical circuit—see http://en.wikipedia.org/wiki/Printed_circuit_board. The disadvantage of this technical solution is that the electricity inside the appliance is transmitted by wire and other conductive elements that increases the cost of the appliance due to need using wires and other conductive elements, which makes the manufacturing these appliances more complex.

It is known a method of transmission of electrical energy without using conductive elements in electrical circuit. Wireless power or wireless energy transmission is the transmission of electrical energy from a power source to an electrical load without man-made conductors. The most common form of wireless power transmission is carried out using direct induction followed by resonant magnetic induction. Other methods under consideration are electromagnetic radiation in the form of microwaves or lasers and electrical conduction through natural media. More information is available at http://enwikipedia.org/wiki/Wireless_power.

It is known a method of transmission of electrical energy without using conductive elements in electrical circuit. This method is used to transmit electrical power to an appliance in order to eliminate the use of wires. For this purpose wireless electrical energy transmission devices (WEETD) are used. Disposed outside of the electronic appliance WEETD transmits electrical energy to specified electronic appliance wirelessly, as a result the electronic appliance can operate. For more details see http://www.witricity.com/.

The above mentioned technical solution is the closest technical solution, which is a prototype of the claimed invention. The disadvantage of the prototype is that WEETD is disposed outside of appliance which consumes electrical energy. Since the air is not the most optimal medium for the transmission of electrical energy, as a result at the wireless transmission of electrical energy from WEETD through the air environment to the appliance, which consumes electrical energy, electrical energy is lost, that reduces WEETD operating efficiency. In addition, in certain cases, transmitting by air significant amounts of energy can be dangerous to health of human located within the WEETD range. In addition, the disadvantage of this technical solution is that the electrical energy inside specified appliance is transmitted by wire and other conductive elements that increases the cost of the appliance due to need using wires and other conductive elements, which makes the manufacturing these appliances more complex.

### DESCRIPTION OF THE INVENTION

Task to be solved and the technical result of the claimed invention is to increase the operating efficiency of the wireless electrical energy transmission device and to reduce the potential hazard of the wireless electrical energy transmission device to humans.

With a view of correct understanding and interpretation of used in the present invention terms the following terminology has been used:

Appliance is an electronic or automatic and any other appliance, which requires electrical power supply to operate. Such appliances are, for example, a mobile phone or device equipped with a mobile or a radio communications, or a computer, or a notebook, or a netbook, or a PDA, or smart phone, or multimedia electronic device, or tablet PC, or a TV set, or a monitor, or video projector, or an electronic book or electronic newspaper, or a printer, or scanner, or copier, or a camera, or a video camera, or digital binoculars, or a digital sight, or night vision device, or an electronic telescope, or Global Positioning System, or navigation device, or electric shaver, or fax device, or remote control device, or equipment for digital printing, or equipment for operational printing, or refrigerator, or washing machine, or dishwasher, or electric stove, or air conditioner, or air-conditioner, or split system, or heating device with electronic control, or microwave oven, or coffee maker with electronic control, or juice maker with electronic control, or cooking device with electronic control, or food processor with electronic control, or machine with electronic control, or electronic control unit, or equipment with electronic control, or robot with electronic control, or lighting device with electronic control, or safe with electronic control, or device that is a part of a robot, or a machine, or equipment, or plant, or another known device, including at least one electronic device or at least one above mentioned technical mean.

Specified technical result is achieved as follows:

An appliance, which requires electrical power supply to operate, comprising at least one wireless electrical energy transmission device (WEETD), wherein at least one specified WEETD is accommodated fully or partially inside specified appliance housing.

A wireless transmission of electrical energy to at least one technical mean, which is an integral part of the appliance, is carried out through at least one WEETD.

At least one WEETD can be attached to: a) at least one technical mean of the appliance with or without ability to undock, and/or b) to the housing of said appliance with or without ability to undock.

Said WEETD attachment can be configured to move relative to said technical mean and/or relative to the housing of said appliance.

At least one WEETD can be built in at least one technical mean of the appliance and/or in the housing of said appliance.

The source of electric power supply for WEETD can be: a) at least one electric power supply source, disposed wholly or partially inside the appliance housing, and/or b) at least one electric power supply source, disposed in whole or in part on the appliance housing, and/or c) at least one electric power supply source, disposed outside the appliance housing.

WEETD can be connected to the electric power supply source or sources by wire and/or wireless.

The electric power supply source for WEETD can be a DC electric power supply source and/or an AC electric power supply source.

The electric power supply source for WEETD can be at least one accumulator battery and/or at least one solar panel.

The appliance housing can be fully or partially shielded from the inside of the appliance housing and/or fully or partially from the outside of the appliance housing.

In case of accommodating WEETD partly inside the appliance housing the WEETD can be fully or partially separated from the external environment by protective construction.

The protective construction can be made of dielectric materials and/or materials, which include dielectric materials.

The appliance housing can be made entirely or partly of dielectric materials and/or materials, which include dielectric materials.

The WEETD housing can be fully or partially made of dielectric materials and/or materials, which include dielectric materials.

The WEETD housing can be fully or partially shielded from the inside and/or outside.

At least one technical mean of the appliance can be supplied by electric power from at least one WEETD by means of using at least one receiver and/or adapter.

The receiver can be installed in specified technical mean of the appliance, or can be attached to specified technical mean of the appliance.

The adapter can be installed in specified technical mean of the appliance, or can be attached to specified technical mean of the appliance.

At least one technical mean of the appliance can be supplied by electric power from at least one WEETD without using a receiver and/or adapter.

The appliance can be configured to provide information related to the operation of at least one WEETD. Said information is provided in a visual and/or audible form.

The electricity conductive environment can be created inside the appliance housing.

The liquid electricity conductive agent or liquid electrical conductor can be set inside the appliance housing.

The appliance can be a mobile phone, or device equipped with a mobile or a radio communications, or a computer, or a notebook, or a netbook, or a PDA, or smart phone, or multimedia electronic device, or tablet PC, or a TV set, or a monitor, or video projector, or an electronic book, or electronic newspaper, or a printer, or scanner, or copier, or a camera, or a video camera, or digital binoculars, or a digital sight, or night vision device, or an electronic telescope, or Global Positioning System, or navigation device, or electric shaver, or fax device, or remote control device, or equipment for digital printing, or equipment for operational printing, or refrigerator, or washing machine, or dishwasher, or electric stove, or air conditioner, or air-conditioner, or split system, or heating device with electronic control, or microwave oven, or coffee maker with electronic control, or juice maker with electronic control, or cooking device with electronic control, or food processor with electronic control, or machine with electronic control, or electronic control unit, or equipment with electronic control, or robot with electronic control, or lighting device with electronic control, or safe with electronic control, or device that is a part of a robot, or a machine, or equipment, or plant, or another known device, including at least one electronic device or at least one above mentioned technical mean.

### EMBODIMENT OF THE INVENTION

The invention is technically feasible as in the prior art all the technical means, components and materials, that allow to implement the claimed invention, are known.

### APPLICATION OF THE INVENTION

The invention can be used to increase the operating efficiency of device for the wireless transmission of electrical energy and to reduce the potential hazard of device for the wireless transmission of electrical energy to humans.

1. An appliance, which requires electrical power supply to operate, comprising at least one wireless electrical energy transmission device (WEETD), wherein at least one specified WEETD is accommodated fully or partially inside specified appliance housing, herewith a wireless transmission of electrical energy to at least one technical mean, which is an integral part of the appliance, is carried out through at least one WEETD.

2. The appliance according to claim 1, wherein at least one WEETD is attached to: a) at least one technical mean of the appliance with or without ability to undock, and/or b) to the housing of said appliance with or without ability to undock.

3. The appliance according to claim 2, wherein said WEETD attachment is configured to move relative to said technical mean and/or relative to the housing of said appliance.

4. The appliance according to claim 1, wherein at least one WEETD is built in at least one technical mean of the appliance and/or in the housing of said appliance.

5. The appliance according to claim 1, wherein the source of electric power supply for WEETD is:
a) at least one electric power supply source, disposed wholly or partially inside the appliance housing, and/or b) at least one electric power supply source, disposed in whole or in part on the appliance housing, and/or c) at least one electric power supply source, disposed outside the appliance housing.

6. The appliance according to claim 5, wherein WEETD is connected to the electric power supply source or sources by wire and/or wireless.

7. The appliance according to claim 5, wherein a DC electric power supply source and/or an AC electric power supply source is the electric power supply source for WEETD.

8. The appliance according to claim 5, wherein at least one accumulator battery and/or at least one solar panel is the electric power supply source for WEETD.

9. The appliance according to claim 1, wherein the appliance housing is fully or partially shielded from the inside of the appliance housing and/or fully or partially from the outside of the appliance housing.

10. The appliance according to claim 1, wherein the appliance housing is made entirely or partly of dielectric materials and/or materials, which include dielectric materials.

11. The appliance according to claim 1, wherein in case of accommodating WEETD partly inside the appliance housing the WEETD is fully or partially is separated from the external environment by protective construction.

12. The appliance according to claim 11, wherein the protective construction is made of dielectric materials and/or materials, which include dielectric materials.

13. The appliance according to claim 1, wherein at least one technical mean of the appliance is supplied by electric power from at least one WEETD by means of using at least one receiver and/or adapter.

14. The appliance according to claim 13, wherein the receiver is installed in specified technical mean of the appliance, or is attached to specified technical mean of the appliance.

15. The appliance according to claim 13, wherein the adapter is installed in specified technical mean of the appliance, or is attached to specified technical mean of the appliance.

16. The appliance according to claim 1, wherein the appliance is configured to provide information related to the operation of at least one WEETD.

17. The appliance according to the claim 16, wherein said information is provided in a visual and/or audible form.

18. The appliance according to claim 1, wherein the appliance is a mobile phone, or device equipped with a mobile or a radio communications, or a computer, or a notebook, or a netbook, or a PDA, or smart phone, or multimedia electronic device, or tablet PC, or a TV set, or a monitor, or video projector, or an electronic book, or electronic newspaper, or a printer, or scanner, or copier, or a camera, or a video camera, or digital binoculars, or a digital sight, or night vision device, or an electronic telescope, or Global Positioning System, or navigation device, or electric shaver, or fax device, or remote control device, or equipment for digital printing, or equipment for operational printing, or refrigerator, or washing machine, or dishwasher, or electric stove, or air conditioner, or air-conditioner, or split system, or heating device with electronic control, or microwave oven, or coffee maker with electronic control, or juice maker with electronic control, or cooking device with electronic control, or food processor with electronic control, or machine with electronic control, or electronic control unit, or equipment with electronic control, or robot with electronic control, or lighting device with electronic control, or safe with electronic control, or device that is a part of a robot, or a machine, or equipment, or plant, or another known device, including at least one electronic device or at least one above mentioned technical mean.

19-22. (canceled)
